(19) United States
(12) Patent Application Publication
(10) Pub. No.: US 2009/0027425 A1
(43) Pub. Date: Jan. 29, 2009

(54) DISPLAY DEVICE AND DRIVING METHOD FOR DISPLAY DEVICE

(76) Inventors: Jong-Woung Park, Seongnam-si (KR); Yun-Tae Kim, Suwon-si (KR); Sung-Woo Lee, Suwon-si (KR); Byung-Ki Jeon, Seoul (KR); Ju-Yong Park, Seoul (KR); Kee-Han Uh, Yongin-si (KR); Joo-Hyung Lee, Gwacheon-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/176,807

(22) Filed: Jul. 21, 2008

(30) Foreign Application Priority Data
Jul. 24, 2007 (KR) 10-2007-0074235

(51) Int. Cl. G09G 5/10

(52) U.S. Cl. 345/690

(57) ABSTRACT

A display device includes: a display panel which comprises sub-pixels including an R sub-pixel, a G sub-pixel, a B sub-pixel and a W sub-pixel and disposed in a matrix form, a gate line and a data line which insulatingly cross each other and transmit a driving signal to the sub-pixels; a driver connected to the gate line and the data line; and a signal controller which comprises a signal converter including a W extracting unit to convert R, G and B image signals into R, G, B and W image signals and a rendering unit to render the R, G, B and W image signals so that eight sub-pixels adjacent in an extending direction of the gate line display three pixels, and controls the driver to apply rendered image signals to the display panel.

### CROSS-REFERENCE TO RELATED APPLICATIONS

This application claims priority from Korean Patent Application No. 10-2007-0074235, filed on Jul. 24, 2007 in the Korean Intellectual Property Office, the disclosure of which is incorporated herein by reference.

### BACKGROUND OF INVENTION

1. Field of Invention

Apparatus and methods consistent with the present invention relate to a display device and a driving method for a display device and, more particularly, to a display device which includes a W sub-pixel.

2. Description of the Related Art

Flat panel display devices, such as liquid crystal displays (LCDs), organic light emitting diodes (OLEDs) often include a red (R) sub-pixel, green (G) sub-pixel and blue (B) sub-pixel. Sub-pixels of different colors are formed with color filters of different colors or light emitting layers which emit different colors of light.

The display devices display images by controlling the color and light transmittance (brightness) of each of the pixels (dots) which includes at least one R, G and B sub-pixels.

Recently, a RGBW method where a white (W) sub-pixel is provided in addition to R, G and B sub-pixels has been developed to improve brightness. In the RGBW method input image signals of three colors are used to form pixel voltages of four colors and each pixel is driven considering brightness of neighboring pixels.

A conventional RGBW method includes a 6 to 3 type where three R, G, B and W sub-pixels are formed in an area of six sub-pixels. The conventional RGB method includes a 6 to 4 type where four R, G, B and W sub-pixels are formed in an area of six sub-pixels in an RGB method.

In the conventional RGBW method, however, brightness increases while visibility decreases. Display devices used for portable equipment mostly require a low resolution of 200 ppi or less that may particularly decrease visibility if the display device employs the conventional RGBW method.

### SUMMARY OF THE INVENTION

Accordingly, it is an aspect of the present invention to provide a display device with high brightness and suitable visibility.

Another aspect of the present invention is to provide a driving method that yields a display device having high brightness and good visibility.

According to an aspect of the present invention, a display device comprises: a display panel having sub-pixels such as an R sub-pixel, a G sub-pixel, a B sub-pixel and a W sub-pixel disposed in a matrix form, a gate line and a data line which insulatingly cross each other and transmit a driving signal to the sub-pixels; a driver connected to the gate line and the data line; and a signal controller which comprises a signal converter including a W extracting unit to convert R, G and B image signals into R, G, B and W image signals and a rendering unit to render the R, G, B and W image signals so that eight sub-pixels adjacent in an extending direction of the gate line display three pixels, and controls the driver to apply rendered image signals to the display panel.

Four sub-pixels adjacent in the extending direction of the gate line may display different colors.

A pair of the sub-pixels adjacent in an extending direction of the data line may display different colors.

The W sub-pixels may be disposed at regular intervals in the extending direction of the gate line.

The display panel may have a resolution of 140 ppi to 200 ppi.

A display area of the display panel may have a rectangular shape of which a diagonal length is 2 to 2.5 inch, and the display panel has a resolution of QVGA.

The respective sub-pixels may have a rectangular shape of which an aspect ratio is approximately 3:8.

According to another aspect of the present invention a display device driving method comprises: W-extracting to convert R, G and B image signals into R, G, B and W image signals; rendering the converted R, G, B and W image signals so that eight sub-pixels adjacent in an extending direction of the gate line display three pixels; and applying the rendered image signals to the display panel.

Four sub-pixels adjacent in the extending direction of the gate line may display different colors, a pair of the sub-pixels adjacent in an extending direction of the data line display different colors, and the W sub-pixels may be disposed at regular intervals in the extending direction of the gate line.

The display panel may have a resolution of 140 ppi to 200 ppi.

The foregoing and/or other aspects of the present invention can be achieved by providing a display device comprising: a display panel which comprises sub-pixels including an R sub-pixel, a G sub-pixel, a B sub-pixel and a W sub-pixel and disposed in a matrix form, a gate line and a data line which insulatingly cross each other and transmit a driving signal to the sub-pixels; a driver connected to the gate line and the data line; and a signal controller which comprises a signal converter including a W extracting unit to convert R, G and B image signals input from the outside into R, G, B and W image signals and a rendering unit to render the R, G, B and W image signals so that twelve sub-pixels adjacent in an extending direction of the gate line display five pixels, and controls the driver to apply rendered image signals to the display panel.

Four sub-pixels adjacent in the extending direction of the gate line may display different colors.

A pair of the sub-pixels adjacent in an extending direction of the data line may display different colors.

The W sub-pixels may be disposed at regular intervals in the extending direction of the gate line.

The display panel may have a resolution of 140 ppi to 200 ppi.

A display area of the display panel may have a rectangular shape of which a diagonal length is 2 to 2.5 inch, and the display panel has a resolution of QVGA.

The respective sub-pixels may have a rectangular shape of which an aspect ratio is approximately 5:12.

The foregoing and/or other aspects of the present invention can be achieved by providing a driving method of a display device which comprises sub-pixels including an R sub-pixel, a G sub-pixel, a B sub-pixel and a W sub-pixel and disposed in a matrix form, a gate line and a data line which insulatingly cross each other and transmit a driving signal to the sub-pixels, comprising: W-extracting to convert R, G and B image signals input from the outside into R, G, B and W image signals; rendering the converted R, G, B and W image signals so that twelve sub-pixels adjacent in an extending direction of the gate line display five pixels; and applying the rendered image signals to the display panel.

Four sub-pixels adjacent in the extending direction of the gate line may display different colors, a pair of the sub-pixels adjacent in an extending direction of the data line display different colors, and the W sub-pixels are disposed at regular intervals in the extending direction of the gate line.

The display panel may have a resolution of 140 ppi to 200 ppi.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is an arrangement view of a display device according to a first exemplary embodiment of the present invention;

FIG. 2 is an arrangement view of a sub-pixel in the display device according to the first exemplary embodiment of the present invention;

FIG. 3 is a cross-sectional view taken along line 111-111 in FIG. 2;

FIGS. 4A and 4B illustrate a comparison between the sub-pixel in the display device according to the first exemplary embodiment of the present invention and a sub-pixel in a conventional display device;

FIG. 5 illustrates rendering in the display device according to the first exemplary embodiment of the present invention;

FIG. 6 illustrates another arrangement view of the sub-pixel in the display device according to the first exemplary embodiment of the present invention;

FIG. 7 is an arrangement view of a sub-pixel in a display device according to a second exemplary embodiment of the present invention;

FIGS. 8A and 8B illustrate a comparison between the sub-pixel in the display device according to the second exemplary embodiment of the present invention and a sub-pixel in a conventional display device; and

FIG. 9 is another arrangement view of the sub-pixel in the display device according to the second exemplary embodiment of the present invention.

### DETAILED DESCRIPTION OF EXEMPLARY EMBODIMENTS OF THE INVENTION

Reference will now be made in detail to the embodiments of the present invention, examples of which are illustrated in the accompanying drawings, wherein like reference numerals refer to like elements throughout. The embodiments are described below so as to explain the present invention by referring to the figures.

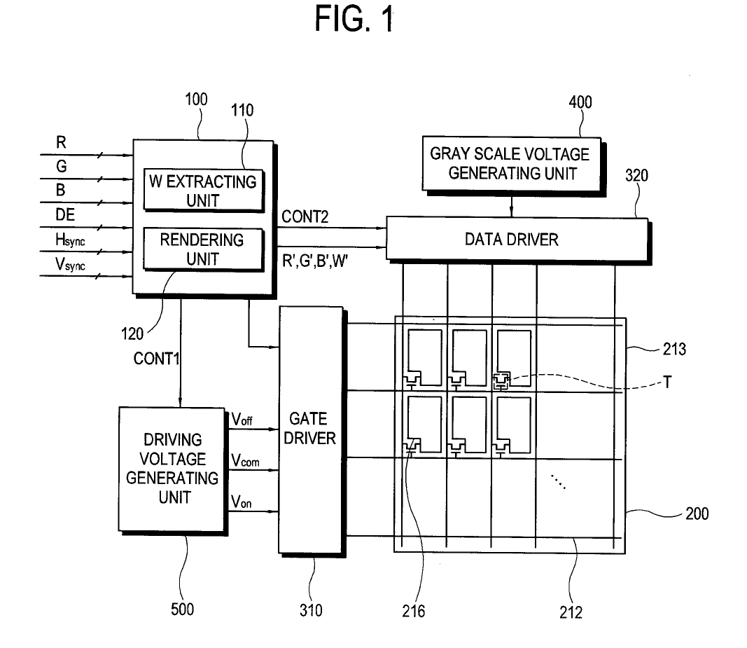

Referring to FIG. 1, a display device according to a first exemplary embodiment includes a signal controller 100, an LCD panel 200 and drivers 310 and 320. In addition, the display device includes a gray scale voltage generating unit 400 and a driving voltage generating unit 500. The signal controller 100 includes a W extracting unit 110 and a rendering unit 120.

A gate line 212 and a data line 213 are formed in the LCD panel 200 and insulated from each other. The gate line 212 and the data line 213 are formed as a single or multi metal layer. The gate line 212 is connected to the gate driver 310, and the data line 213 is connected to the data driver 320.

A thin film transistor (TFT) T is formed at an intersection area of the gate line 212 and the data line 213.

The TFT T is electrically connected to a pixel electrode 216. The TFT T are driven by the gate line 212 and the data line 213 to apply a data voltage (pixel voltage) to the pixel electrode 216.

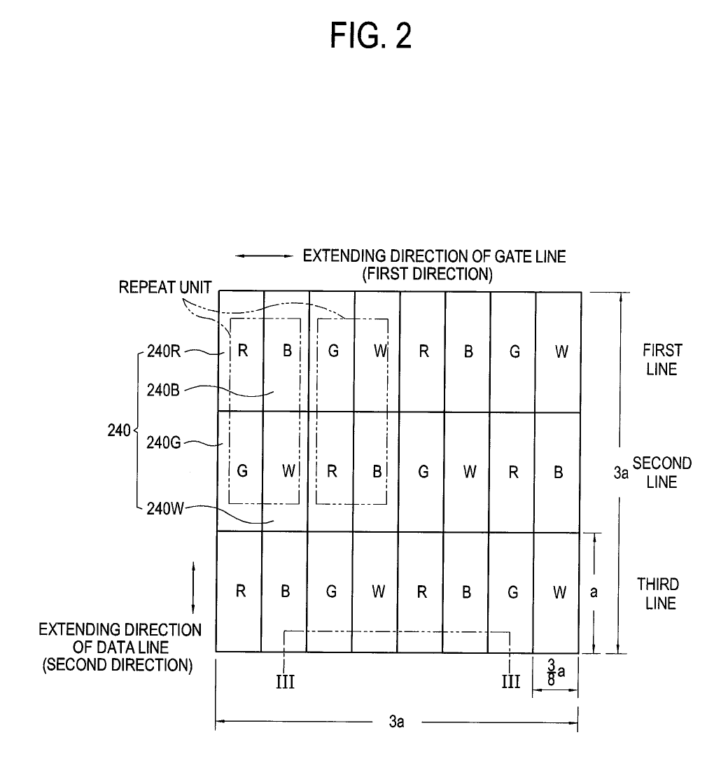

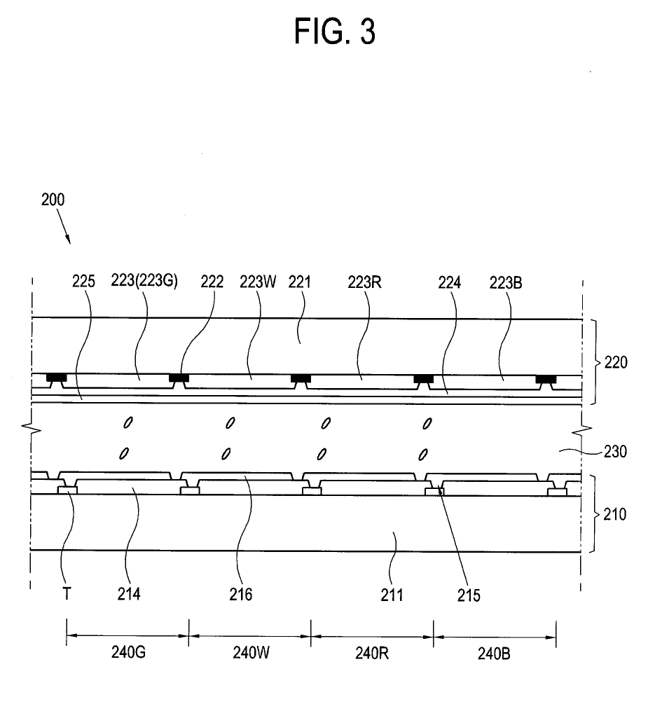

Hereinafter, the LCD panel 200 is described in detail with reference to FIGS. 2 and 3. The LCD panel 200 may be in a rectangular shape and has a display region of a rectangular shape. A plurality of sub-pixels 240 is formed in the display region.

In the description, a term of sub-pixel refers to a unit which can display different levels of brightness but a single color. Meanwhile, a term of pixel refers to a unit which may display not only different levels of brightness but also desired colors and is also called a dot.

Referring to FIG. 2, the sub-pixels 240 includes an R sub-pixel 240R which displays a red color in different levels of brightness, a G sub-pixel 240G which displays a green color in different levels of brightness, a B sub-pixel 240B which displays a blue color in different levels of brightness and a W sub-pixel 240W which displays white color in different levels of brightness. In the exemplary embodiments, the sub-pixels 240 are surrounded by the gate line 212 and the data line 213 and have a rectangular shape.

Referring to FIG. 3, the LCD panel 200 includes a first substrate 210, a second substrate 220 and a liquid crystal layer 230.

As for the first substrate 210, the TFT T is formed on a first insulating substrate 211. The first insulating substrate 211 may be made of glass, quartz or plastics. As shown in FIG. 1, the TFT T is connected to the gate line 212 and the data line 213.

An insulating layer 214 is formed on the TFT T. The insulating layer 214 may be made of an inorganic material such as silicon nitride, silicon oxide and the like, or have a double layer of an inorganic layer and an organic layer. A contact hole 215 is formed in the insulating layer 214 and exposes the TFT T.

The pixel electrode 216 is formed on the insulating layer 214. The pixel electrode 216 is electrically connected to the contact hole 215 and applied with a data voltage from the TFT T. The pixel electrode 216 is made of a transparent conductive material such as indium tin oxide (ITO) or indium zinc oxide (IZO) and divided into sub-pixels 240.

As for the second substrate 220, a black matrix 222 is formed on a second insulating substrate 221. The second insulating substrate 221 may be made of glass, quartz or plastics. The black matrix 222 prevents light from the outside from being irradiated to the TFT T.

A color filter layer 223 is disposed between the black matrixes 222. The color filter layer 223 includes a red color filter 223R, a green color filter 223G, a blue color filter 223B and a transparent color filter 223W, which each are formed on the respective sub-pixel 240. Light provided from a backlight unit (not shown) behind the first substrate 210 is adjusted in transmittance while passing through the liquid crystal layer 230 and is endowed with color while passing through the color filter 223.

An overcoat layer 224 is formed on the color filter 223. The overcoat layer 224 protects the color filter layer 223 and provides a planar surface, which can be omitted.

A common electrode 225 is formed on the overcoat layer 224. The common electrode 225 is formed throughout the display region and made of a transparent conductive material as well as the pixel electrode 216.

The common electrode 225 is applied with a common voltage, and the pixel electrode 216 is applied with a data voltage. Liquid crystal molecules in the liquid crystal layer 230 are variable in their orientation by a voltage difference between a common voltage and a data voltage, thereby adjusting transmittance of light.

Returning to FIG. 2, an arrangement of the sub-pixels 240 are explained in detail.

The sub-pixels 240 are arranged in a matrix form. The red (R), blue (B), green (G) and white (W) sub-pixels 240 are sequentially and repeatedly formed in an odd-numbered line in a first direction parallel with an extending direction of the gate line 212, and the G, W, B and R sub-pixels 240 are sequentially and repeatedly formed in an even-numbered line. Neighboring sub-pixels 240 in a second direction parallel with an extending direction of the data line 213 display different colors.

Regarding four sub-pixels 240 of R, W, G and B disposed two by two as a repeat unit, a pair of repeat units which is adjacent in the first direction has different configurations where sub-pixels in the upper line are exchanged with sub-pixels in the lower line in their positions.

As described above, the sub-pixels 240 of four colors are formed in each line at the same ratio along the first direction, and thus color balancing is excellent. In addition, sub-pixels 240 of the same color are not adjacent in the second direction, thereby improving color balancing.

If the length of the respective sub-pixels 240 is given as a, the width thereof is about 3/8a. That is, the sub-pixels 240 have a rectangular shape of which an aspect ratio is about 3:8. FIG. 2 shows 24 sub-pixels 240 disposed eight by three, which are disposed in a square area of 3a wide and 3a long.

Going back to FIG. 1, the gate driver 310 is referred to as a scan driver and connected to the gate line 212 to apply a gate signal to the gate line 210, the gate signal consisting of a combination of a gate-on voltage Von and a gate-off voltage Voff which are from the driving voltage generating unit 500.

The data driver 320 is referred to as a source driver. The data driver 530 is applied with a gray scale voltage from the gray scale voltage generating unit 400, selects a gray scale voltage according to control by the signal controller 100 and applies it as a data voltage to the data line 213.

A gate driver integrated circuit (IC) forming the gate driver 310 or a data driver IC forming the data driver 320 may be mounted on a tape carrier package (TCP) (not shown) and the TCP may be adhered to the LCD panel 200. The driver ICs may be adhered directly to the first insulating substrate 211, which is called a chip on glass (COG) type. Also, a circuit which functions as these ICs may be formed on the LCD panel 200.

The driving voltage generating unit 500 generates a gate-on voltage (Von) to turn on the TFT T, a gate-off voltage (Voff) to turn it off and a common voltage (Vcom) to be applied to the common electrode 225.

The gray scale voltage generating unit 400 generates a plurality of gray scale voltages which are related to brightness.

The signal controller 100 converts and renders an image signal input from the outside and generates a control signal which controls operations of the gate driver 310, the data driver 320, the driving voltage generating unit 500 and the gray scale voltage generating unit 400. In the description, a term of driving signal refers to both a control signal and a converted and rendered image signal.

The signal controller 100 receives R, G and B image signals (R, G and B) and an input control signal to control display of the R, G and B signals from the outside. Here, the input control signal, for example, includes a vertical synchronizing signal (Vsync), a horizontal synchronizing signal (Hsync), a main clock (MCLK), a data enable signal (DE), etc.

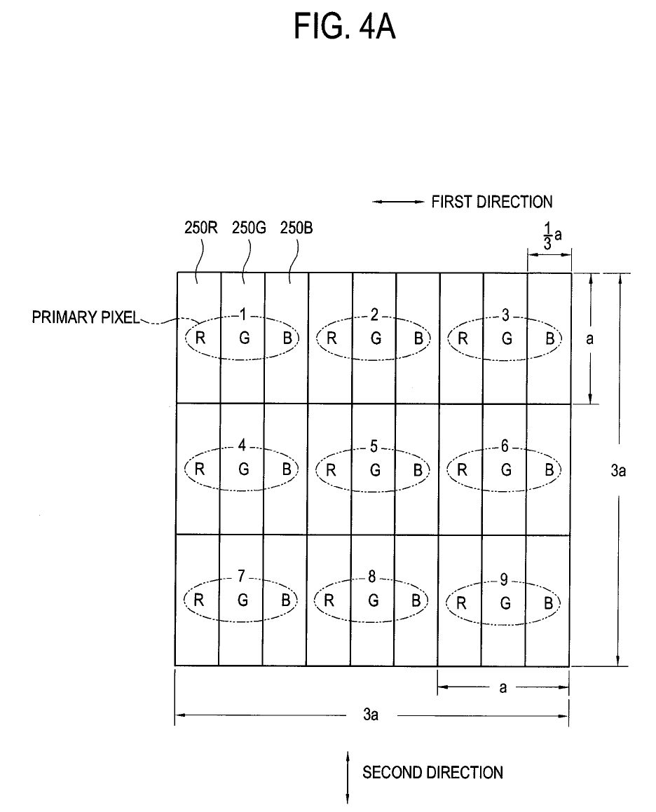

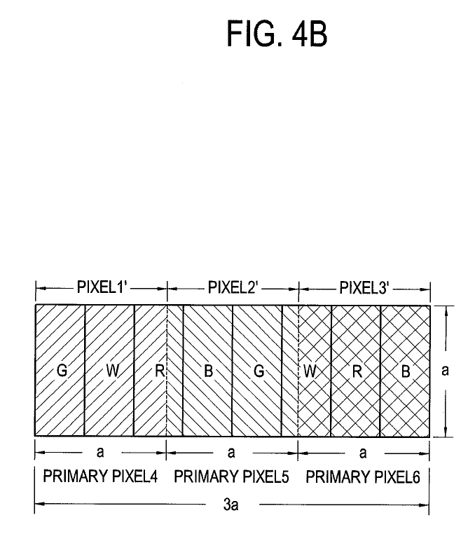

The W extracting unit 110 calculates a brightness value corresponding to each of the primary sub-pixels 250 (refer to FIG. 4A) from R, G and B image signals and converts the R, G and B image signals into R, G, B and W image signals. The converted R, G, B and W image signals are rendered by the rendering unit 120 and converted into R′, G′, B′ and W′ image signals.

The signal controller 100, on the basis of an input control signal, transmits a gate control signal (CONT 1) to the gate driver 310 and the driving voltage generating unit 500, and the rendered image signals of four colors (R′, G′, B′ and W′) and a data control signal (CONT 2) to the data driver 320.

The gate control signal (CONT 1) includes a vertical synchronization start signal (STV) which directs to start outputting a gate on pulse (a range of a gate signal), a gate clock signal (CPV) to control an output time of the gate on pulse, a gate on enable signal (OE) to determine a width of the gate on pulse, and the like.

The data control signal (CONT 2) includes a horizontal synchronization start signal (STH) which indicates to start inputting R′, G′, B′ and W′ image signals, a load signal (LOAD or TP) which indicates to apply a corresponding data voltage to data line 213, and the like.

The gray scale voltage generating unit 400 outputs a gray scale voltage which has a voltage value determined according to a voltage selection control signal (VSC) to the data driver 320.

The gate driver 310 applies the gate-on voltage to the gate line 212 one by one according to a gate control signal from the signal controller 100, thereby turning on the TFT T.

At the same time, the data driver 320 is input with R′, G′, B′ and W′ image signals corresponding to sub-pixels 240 connected to the TFT T which is turned on and selects a gray scale voltage corresponding to each of the R′, G′, B′ and W′ image signals according to the data control signal (CONT 2) from the signal controller 100, thereby converting the R′, G′, B′ and W′ image signals into corresponding data voltages.

The signal controller 100 may further include a gamma control unit (not shown) which adjust gamma characteristics of the rendered R′, G′, B′ and W′ image signals.

The data signal supplied to the data line 213 is applied to a corresponding sub-pixel 240, more specifically, to the pixel electrode 216 of each sub-pixel 240 through the turned on TFT T. In this way, the gate-on voltage (Von) is sequentially applied to every gate line 212 during one frame, and thus the data signal is applied to all the sub-pixels 240.

Hereinafter, it will be explained how the signal controller 100 extracts a W image signal and renders an image signal.

The W extracting unit 110 extracts a W image signal using a method where a white element is extracted from respective binary R, G and B image signals of three colors and processed through a half-tone processor to generate R, G, B and W image signals of four colors; a method where an input value of a white element is provided by subtracting pixel values from increase values of R, G and B image signals of three colors, and increase values of the R, G and B image signals excluding the value of the white element are used as output signals of the R, G and B image signals; and the like.

As necessary, the W extracting unit 110 may remove a gamma correction signal (in the NTSC system, 1/2.2) which is included in the image signals of three colors by channels and slightly convert the R, G and B image signals among the R, G, B and W signals.

Rendering is a technique where sub-pixels 240 are separately driven and at the same time neighboring pixels are also driven when an image is displayed to distribute brightness to the neighboring pixels to display it in dots, thereby not only delicately displaying an oblique or curved line but also adjusting resolution.

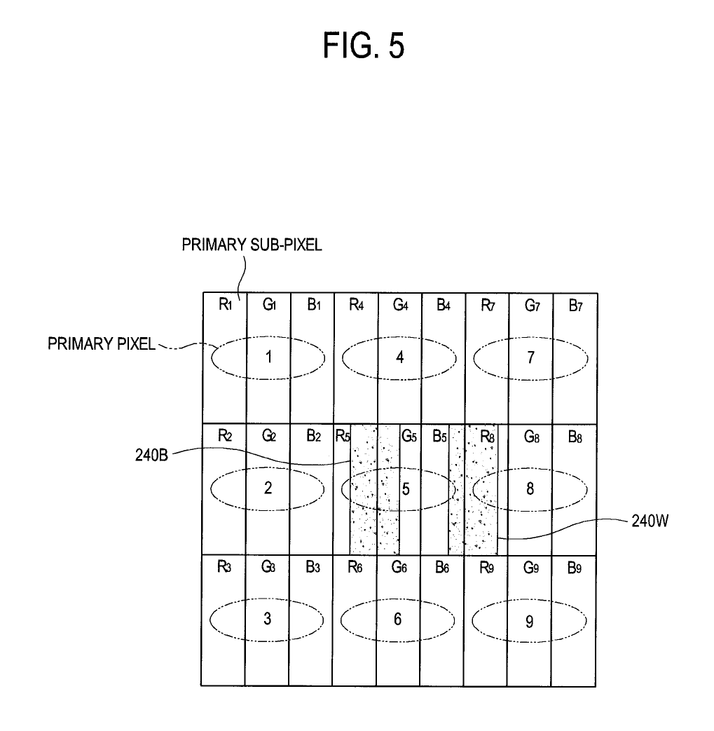

Rendering will be described with reference to FIGS. 4A, 4B and 5.

FIG. 4A illustrates an arrangement of primary sub-pixels 250 in a conventional RGB method disposed in the same display area (3a*3a) as in FIG. 2; and FIG. 4B illustrates the respective sub-pixels 240 disposed in a second line in FIG. 2 by pixel.

Referring to FIG. 4A, primary sub-pixels 250 display red (R), green (G) and blue (B) only, and three R, G and B primary sub-pixels 250 form one primary pixel. That is, three R, G and B sub-pixels 250 adjacent in the first direction represent one primary pixel, and thus nine primary sub-pixels 250 adjacent in the first direction form three primary pixels. Each of the primary sub-pixel 250 has a rectangular shape of which the aspect ratio is 1:3, and each primary pixel has a shape of a square of which both longer and shorter dimensions are given as a.

Referring to FIG. 4B, in the present exemplary embodiment, eight sub-pixels 240 are formed in the display region where nine primary sub-pixels 250 are conventionally disposed. Thus, the aspect ratio of the sub-pixels 240 according to the present exemplary embodiment is 3:8.

In the same display area, the number of sub-pixels 240 decreases, while the eight sub-pixels 240 display three pixels (pixel 1′, pixel 2′ and pixel 3′) through rendering. That is, the display device according to the present embodiment has the same resolution as in the conventional method. Accordingly, each pixel has the same area as the primary pixel. The respective pixels have the same area, and some sub-pixels 240 are disposed over neighboring two pixels.

Rendering will be described in more detail with reference to FIG. 5.

FIG. 5 illustrates sub-pixels 240B and 240W according to the present exemplary embodiment on the arrangement of the conventional primary sub-pixels 250 and the primary pixels.

Nine primary pixels (primary pixels 1 through 9) are disposed in a display region of 3a long by 3a wide. Meanwhile, an image signal input from the outside corresponds to a configuration where three primary sub-pixels 250 display one primary pixel.

For example, in rendering, a B sub-pixel 240B disposed in the pixel 2′ in FIG. 4B considers blue (B) image signals of nine primary pixels in total including its primary pixel and eight primary pixels which surround the pixel.

Namely, the transmittance T(240B) of the B sub-pixel 240B disposed in the pixel 2′ is determined by the following equation:

T(240B)=a1*T(b1)+a2*T(b2)+a3*T(b3)+ . . . +a9*T(b9)

Here, a1 to a9 are given as parameters, and T(b1) indicates the transmittance of a B1 primary sub-pixel in the primary pixel 1.

Meanwhile, a W sub-pixel 240W in the pixel 3′ disposed over the primary pixels 5 and 8 considers white image signals of six primary pixels in total including its two primary pixels (primary pixels 5 and 8) and four primary pixels (primary pixels 4, 6, 7 and 9) neighboring in the second direction.

That is, the transmittance T(240W) of the W sub-pixel 240W disposed over the primary pixel 5 and the primary pixel 8 is determined by the following equation.

T(240W)=b4*T(w4)+b5*T(w5)+ . . . +b9*T(w9)

Here, b4 to b9 are given as parameters, T(w4) indicates a value of a white image signal in the primary pixel 4 calculated by the W extracting unit 110.

Likewise, the R sub-pixels 240R and the G sub-pixels 240G are rendered in the similar method. In the present invention, however, rendering is not limited to the aforementioned method but modified variously.

According to the first exemplary embodiment, the display device displays the same resolution as in the conventional method, while the sub-pixels 240 decrease in number. As the number of sub-pixels 240 decreases to eight-ninth as compared with in the conventional method, the data line 213 also decreases to eight-ninth in number. Namely, the number of data line 213 decreases approximately 11%. Accordingly, a configuration of the data driver 320 becomes simple, thereby reducing its manufacturing cost. Also, as the data line 213 decreases in number, an aperture ratio increases.

Light suffers a substantial amount of loss when passing through the color filters 223R, 223G and 223B, which is about 70%. When light passes through the transparent color filter 223W, i.e., the W sub-pixel 240W, however, the amount of loss considerably decreases. Thus, according to the present exemplary embodiment, a quarter of the sub-pixels 240 are provided with the W sub-pixels 240W, and thus the brightness of the display device increases.

The display region mostly has a rectangular shape. On the test with a quarter video graphics array (QVGA) LCD panel of which a display region has a diagonal length of 2.2 inch, the display device according to the present exemplary embodiment increase about 2% in aperture ratio and about 50% in brightness as compared with a conventional RGB configuration.

In the present exemplary embodiment, brightness increases considerably, but the number of sub-pixels 240 per the same display area decreases only 11% as compared with in the conventional method. The present exemplary embodiment may be efficiently applicable to a display device with certain specifications, e.g., a display device which requires a resolution of 200 ppi and less. The display device with a resolution of 200 ppi and less is generally used for portable electronic equipment. It is 2 to 2.5 inch in size (a diagonal length of a display region), has a QVGA resolution or a resolution of 140 ppi to 200 ppi. QVGA means a device's screen displays 240 (width)×320 (length) pixels.

QVGA display devices in the conventional RGB method need, 720, i.e., 240*RGB, data lines 213. In the present exemplary embodiment, however, 640, i.e., 720*8/9, data lines 213 are necessary. Display signals input from the outside correspond to the 240*RGB. Meanwhile, if the display signals from the outside have a VGA or HVGA resolution, the signal controller 100 converts a VGA or HVGA image signal into a QVGA image signal.

The reason why the present exemplary embodiment is applicable to a display device of 200 ppi and less will be explained with reference to a cycle per degree (CPD) which indicates a visual resolution according to a distance.

The CPD refers to the number of white and black recognized in one pixel line when a user watches a display device which alternately displays white and black on each pixel at a viewing angle of 1 degree at a distance of about 30 cm from the display device. In general, the CPD should be 34 and more for the user to recognize letters or lines.

A resolution of a display device and a configuration of sub-pixels are factors to determine a CPD. In the present exemplary embodiment, a resolution of 150 ppi corresponds to a CPD of 34 in a display region of 2.2 inch. Thus, the display device according to the present exemplary embodiment is suitable for portable equipment which requires a display device of 2 to 2.5 inch in size and 140 ppi to 200 ppi in resolution.

Meanwhile, a 6 to 4 method where four R, G, B and W sub-pixels are formed in an area of six R, G and B sub-pixels requires a resolution of above 200 ppi to satisfy a CPD of 34, and thus it is not applicable to a display device for portable equipment which needs a resolution of 140 ppi to 200 ppi. A 6 to3 method where three R, G, B and W sub-pixels are formed in an area of six R, G and B sub-pixels requires a resolution of well above 200 ppi, and thus it is not suitable for a display device for portable equipment, either.

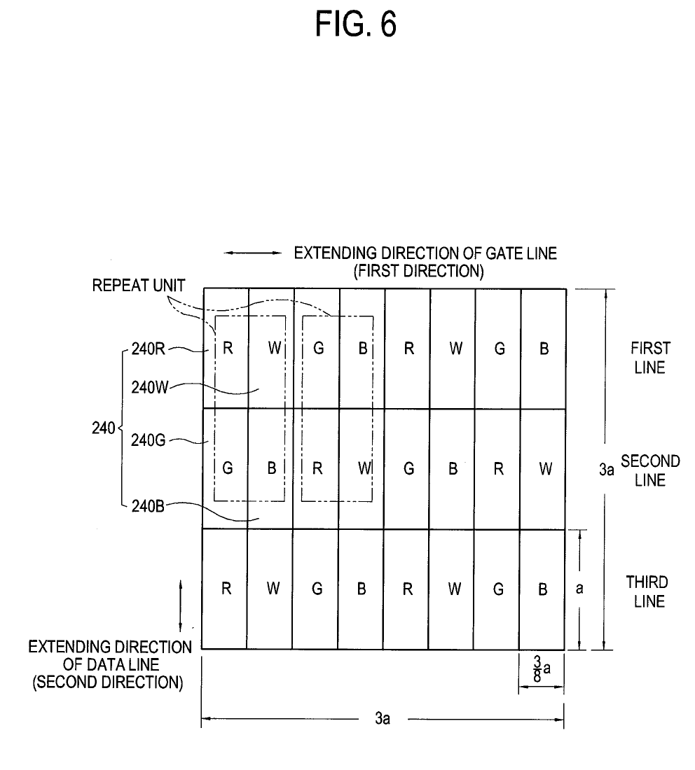

FIG. 6 is another arrangement view of the sub-pixels in the display device according to the first exemplary embodiment of the present invention.

The sub-pixels 240 are arranged in a matrix form. The R, W, G and B sub-pixels 240 are sequentially and repeatedly formed in an odd-numbered line in a first direction parallel with the extending direction of the gate line 212, and the G, B, R and W sub-pixels 240 are sequentially and repeatedly formed in an even-numbered line. Neighboring sub-pixels 240 in the second direction parallel with the extending direction of the data line 213 display different colors.

Regarding four sub-pixels 240 of R, W, G and B disposed two by two as a repeat unit, a pair of repeat units which is adjacent in the first direction has different configurations where sub-pixels in the upper line are exchanged with sub-pixels in the lower line in their positions.

In an arrangement of sub-pixels shown in FIG. 6, the sub-pixels of four colors are formed at the same ratio along the first direction, and thus color balancing is excellent. In addition, sub-pixels 240 of the same color are not adjacent in the second direction, thereby improving color balancing.

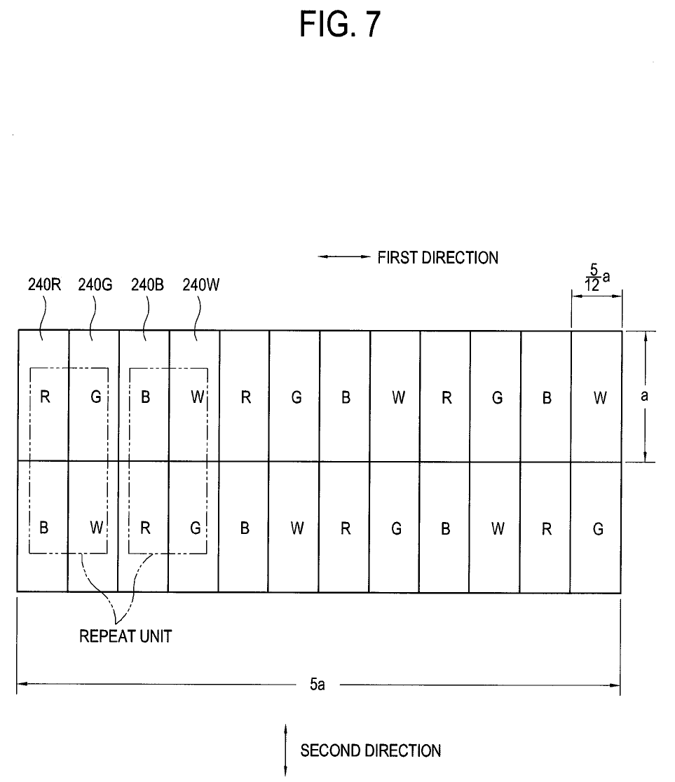

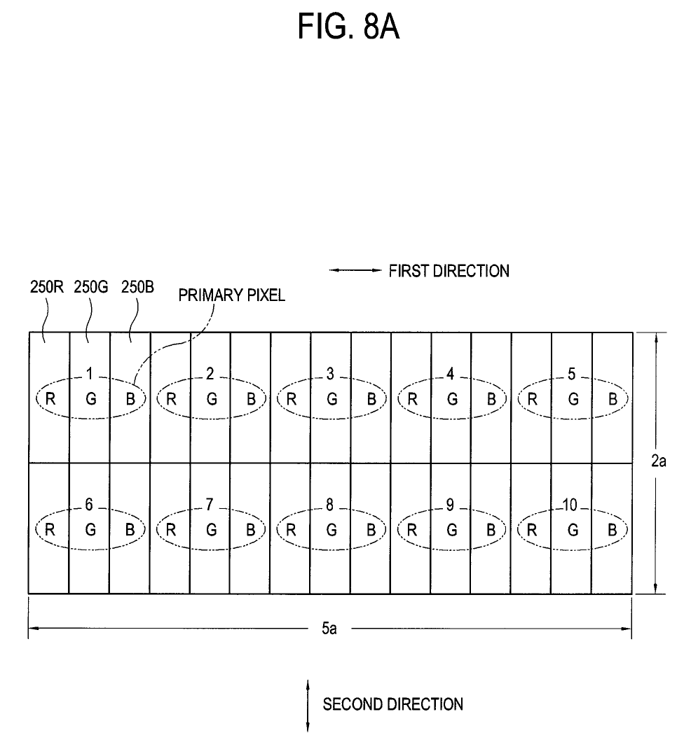

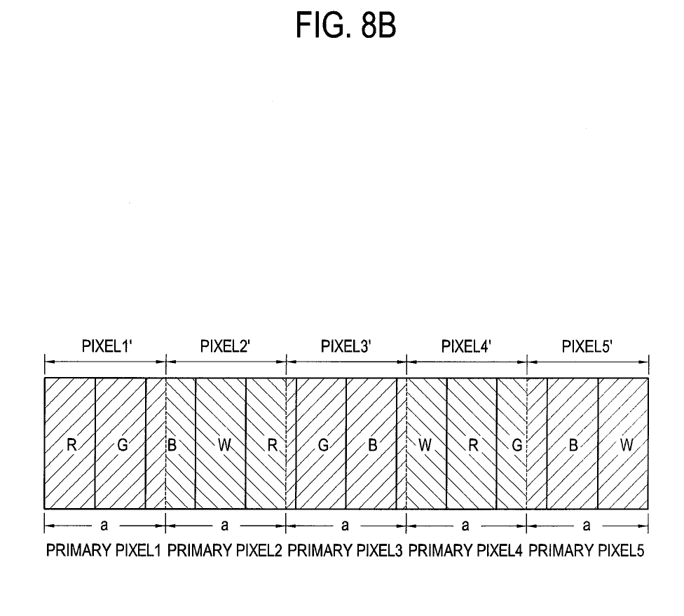

Hereinafter, a second exemplary embodiment of the present invention will be described with reference to FIGS. 7, 8A and 8B.

Sub-pixels 240 are arranged in a matrix form. R, B, G and W sub-pixels 240 are sequentially and repeatedly formed in an odd-numbered line in a first direction parallel with an extending direction of a gate line 212, and G, W, B and R sub-pixels 240 are sequentially and repeatedly formed in an even-numbered line. Neighboring sub-pixels 240 in a second direction parallel with an extending direction of the data line 213 display different colors.

Regarding four sub-pixels 240 of R, W, G and B disposed two by two as a repeat unit, a pair of repeat units which is adjacent in the first direction has different configurations where sub-pixels in the upper line are exchanged with sub-pixels in the lower line in their positions.

As described above, the sub-pixels 240 of four colors are formed in each line at the same ratio along the first direction, and thus color balancing is excellent. In addition, sub-pixels 240 of the same color are not adjacent in the second direction, thereby improving color balancing.

If the length of the respective sub-pixels 240 is given a, the width thereof is about 5/12a. That is, the sub-pixels 240 have a rectangular shape of which an aspect ratio is about 5:12. FIG. 7 shows 24 sub-pixels 240 disposed twelve by two, which have a rectangular shape of 5a wide and 2a long.

Referring to FIGS. 8A and 8B, the arrangement of the sub-pixels 240 according to the present exemplary embodiment will be described as compared with the arrangement of sub-pixels in the conventional RGB method.

FIG. 8A illustrates an arrangement of primary sub-pixels 250 in an RGB method in the same display area of 5a by 2a as in FIG. 7; and FIG. 8B illustrates sub-pixels 240 arranged in a first line in FIG. 7 by pixels.

Referring to FIG. 8A, primary R, G and B sub-pixels 250 are only present in a conventional display device and display one primary pixel (primary pixels 1 to 10). That is, three primary R, G and B sub-pixels 250 adjacent in the first direction display one primary pixel, and thus fifteen primary sub-pixels 250 adjacent in the first direction display five primary pixels. The respective primary sub-pixels 250 have a rectangular shape of which an aspect ratio is 1:3, and each primary pixel has a square shape of which both longer and shorter dimensions are given as a.

Referring to FIG. 8B, in the present exemplary embodiment, twelve sub-pixels 240 are formed in a display area where fifteen primary sub-pixels 250 are conventionally disposed. Thus, an aspect ratio of the sub-pixels 240 according to the present exemplary embodiment becomes 5:12.

In the same area, the number of sub-pixels 240 decreases, while twelve sub-pixels 240 display five pixels (pixels 1′ to 5′) through rendering. The respective pixels are provided with the same shape and size as the primary pixels. That is, the display device according to the present exemplary embodiment has the same resolution as the conventional display device. The respective pixels have the same area, and some of sub-pixels 240 are disposed over neighboring pixels.

A W extracting process and a rendering process in the display device according to the second exemplary embodiment are similar to those in the first exemplary embodiment and so need not be explained.

According to the second exemplary embodiment, the display device displays the same resolution as in the conventional method, while the number of the data line 213 decreases to 12/15, i.e. decreases approximately 20%. Accordingly, a configuration of a data driver 320 becomes simple, thereby reducing its manufacturing cost. Also, as the data line 213 decreases in number, an aperture ratio increases.

Light suffers a substantial amount of loss when passing through color filters 223R, 223G and 223B. When light passes through a transparent color filter 223W, i.e., the W sub-pixel 240W, however, the amount of loss considerably decreases. Thus, according to the present exemplary embodiment, a quarter of the sub-pixels 240 are provided with the W sub-pixels 240W, and thus the brightness of the display device increases.

The display region mostly has a rectangular shape. On the test with a QVGA LCD panel of which a display region has a diagonal length of 2.2 inch, the display device according to the present exemplary embodiment increase about 2% in aperture ratio and about 54% in brightness as compared with a conventional RGB configuration.

Meanwhile, in the present exemplary embodiment, transmittance increases considerably, but the number of sub-pixels 240 per the same display area decreases only 20% as compared with in the conventional display device. Thus, the present exemplary embodiment may be efficiently applicable to a display device with certain specifications, e.g., a display device which requires a resolution of 200 ppi and less. The display device with a resolution of 200 ppi and less is generally used for portable electronic equipment such as a cellular phone. It is 2 to 2.5 inch in size (a diagonal length of a display region), has a QVGA resolution or a resolution of 140 ppi to 200 ppi. QVGA means a device's screen displays 240 (width)×320 (length) pixels.

Display devices in the conventional RGB method need, 720, i.e., 240*RGB, data lines 213. In the present exemplary embodiment, however, 576, i.e., 720*12/15, data lines 213 are necessary. Display signals input from the outside correspond to the 240*RGB. Meanwhile, if the display signals from the outside have a VGA or HVGA resolution, the display device 1 converts a VGA or HVGA image signal into a QVGA image signal.

In the present exemplary embodiment, a resolution of 165 ppi corresponds to a CPD of 34 in a display region of 2.2 inch. Thus, the display device according to the present exemplary embodiment is suitable for portable equipment which requires a display device of 2 to 2.5 inch in size and 140 ppi to 200 ppi in resolution.

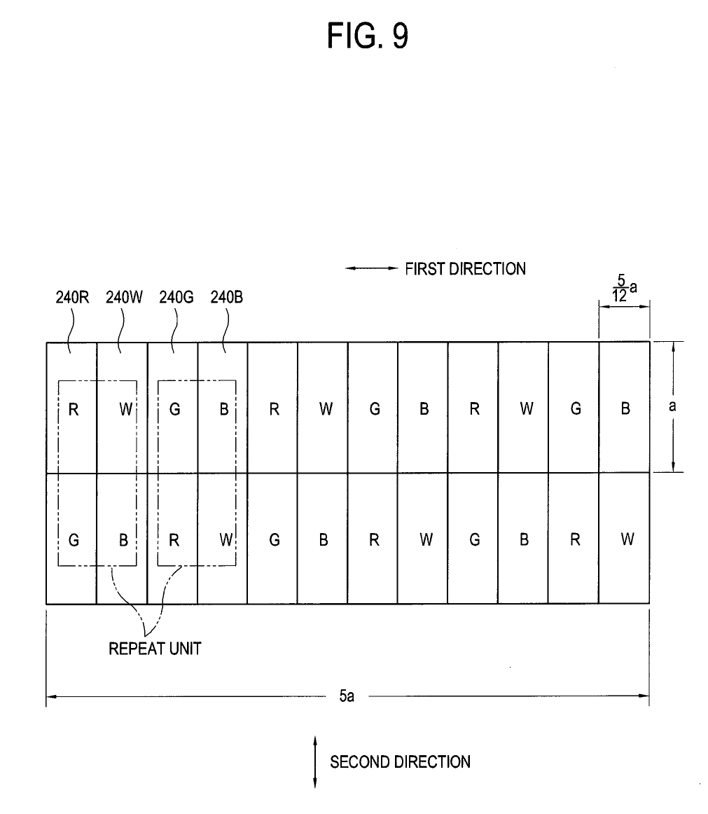

Referring to FIG. 9, another arrangement view of the sub-pixels in the display device according to the first exemplary embodiment of the present invention.

The sub-pixels 240 are arranged in a matrix form. The R, W, G and B sub-pixels 240 are sequentially and repeatedly formed in an odd-numbered line in the first direction parallel with the extending direction of the gate line 212, and the G, B, R and W sub-pixels 240 are sequentially and repeatedly formed in an even-numbered line. Neighboring sub-pixels 240 in the second direction parallel with the extending direction of the data line 213 display different colors.

Regarding four sub-pixels 240 of R, W, G and B disposed two by two as a repeat unit, a pair of repeat units which is adjacent in the first direction has different configurations where sub-pixels in the upper line are exchanged with sub-pixels in the lower line in their positions.

In an arrangement of sub-pixels shown in FIG. 9, the sub-pixels 240 of four colors are formed at the same ratio along the first direction, and thus color balancing is excellent. In addition, sub-pixels 240 of the same color are not adjacent in the second direction, thereby improving color balancing.

As described above, the present invention provides a display device with high brightness and suitable visibility.

Further, a driving method of a display device with high brightness and suitable visibility is also provided.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display device comprising:
a display panel which comprises sub-pixels including an R sub-pixel, a G sub-pixel, a B sub-pixel and a W sub-pixel disposed in a matrix form,
a gate line and a data line which insulatingly cross each other and transmit a driving signal to the sub-pixels;
a driver connected to the gate line and the data line; and
a signal controller which comprises a signal converter including a W extracting unit to convert R, G and B image signals into R, G, B and W image signals and a rendering unit that renders the R, G, B and W image signals so that eight adjacent sub-pixels display three pixels, and that controls the driver to apply rendered image signals to the display panel.

2. The display device according to claim 1, wherein four sub-pixels adjacent in an extending direction of the gate line display different colors.

3. The display device according to claim 2, wherein a pair of the sub-pixels adjacent in an extending direction of the data line display different colors.

4. The display device according to claim 2, wherein the W sub-pixels are disposed at regular intervals in the extending direction of the gate line.

5. The display device according to claim 1, wherein the display panel has a resolution of 140 ppi to 200 ppi.

6. The display device according to claim 1, wherein a display area of the display panel has a rectangular shape of which a diagonal length is 2 to 2.5 inches, and the display panel has a resolution of QVGA.

7. The display device according to claim 1, wherein the respective sub-pixels have a rectangular shape of which an aspect ratio is approximately 3:8.

8. A driving method for a display device comprising:
W-extracting to convert R, G and B image signals into R, G, B and W image signals;
rendering the converted R, G, B and W image signals so that eight adjacent sub-pixels display three pixels; and
applying the rendered image signals to the display panel.

9. The driving method of the display device according to claim 8, wherein four adjacent sub-pixels display different colors,
a pair of the sub-pixels adjacent in a direction of a data line display different colors, and
the W sub-pixels are disposed at regular intervals in the direction of a gate line.

10. The driving method of the display device according to claim 8, wherein the display panel has a resolution of 140 ppi to 200 ppi.

11. A display device comprising:
a display panel which comprises sub-pixels including an R sub-pixel, a G sub-pixel, a B sub-pixel and a W sub-pixel disposed in a matrix form, a gate line and a data line which insulatingly cross each other and transmit a driving signal to the sub-pixels;
a driver connected to the gate line and the data line; and
a signal controller which comprises a signal converter including a W extracting unit to convert R, G and B image signals into R, G, B and W image signals and a rendering unit to render the R, G, B and W image signals so that twelve sub-pixels adjacent in the direction of the gate line display five pixels, and controls the driver to apply rendered image signals to the display panel.

12. The display device according to claim 11, wherein four sub-pixels adjacent in the direction of the gate line display different colors.

13. The display device according to claim 12, wherein a pair of the sub-pixels adjacent in the direction of the data line display different colors.

14. The display device according to claim 12, wherein the W sub-pixels are disposed at regular intervals in the direction of the gate line.

15. The display device according to claim 11, wherein the display panel has a resolution of 140 ppi to 200 ppi.

16. The display device according to claim 11, wherein a display area of the display panel has a rectangular shape of which a diagonal length is 2 to 2.5 inches, and the display panel has a resolution of QVGA.

17. The display device according to claim 11, wherein the respective sub-pixels have a rectangular shape of which an aspect ratio is approximately 5:12.

18. A driving method of a display device comprising:
W-extracting to convert R, G and B image signals into R, G, B and W image signals;
rendering the converted R, G, B and W image signals so that twelve adjacent sub-pixels the direction of a gate line display five pixels; and
applying the rendered image signals to the display panel.

19. The driving method of the display device according to claim 18, wherein four sub-pixels adjacent in the direction of the gate line display different colors, and
a pair of the adjacent sub-pixels the direction of a data line display different colors.

20. The driving method of the display device according to claim 18, wherein the display panel has a resolution of 140 ppi to 200 ppi.
